(19) United States
(12) Patent Application Publication
(10) Pub. No.: US 2015/0021435 A1
(43) Pub. Date: Jan. 22, 2015

(54) Apparatus for causing an aircraft wheel to rotate

(71) Applicants: Mohammad Taghi Abbasszadeh, Zarinshahr (IR); Mehrdad Abbasszadeh, Zarinsha (IR)

(72) Inventors: Mohammad Taghi Abbasszadeh, Zarinshahr (IR); Mehrdad Abbasszadeh, Zarinsha (IR)

(21) Appl. No.: 13/945,762

(22) Filed: Jul. 18, 2013

(51) Int. Cl. B64C 25/40

(52) U.S. Cl. CPC B64C 25/40
USPC 244/103 S

(57) ABSTRACT

A rotator assembly for rotating an aircraft landing wheel by the action of the airstream flowing thereby has a circular plate mounted on the wheel and a plurality of independently movable cone shape connected to the outer surface of the plate in circumferentially spaced relation. Each cone shape member has a circle leading edge facing generally in the direction in which the wheel is to be rotated. As the wheel rotates, the members, which were previously pivoted outward, become engaged by the airstream and are sequentially forced inward against the plate.

### CLAIMS OF PRIORITY

This application claims priority to U.S. Provisional Application No. 61/672,886 entitled “ Mechanism of reduce horizontal friction in airplane landing” filed Jul. 18, 2012 by Mohammad Taghi Abbasszadeh.

### BACKGROUND OF THE INVENTION

1. Field of the Invention

This invention relates generally to aircraft landing wheels, and more particularly to an aircraft landing wheel rotator having a plurality of independently movable outwardly pivoting air cone shape members which can be selectively extended outward relative to the landing wheel surface to expose a much larger surface area to engage the airstream on the power cycle of rotation than is exposed on the return cycle for maximum net torque.

2. Brief Description of the Prior Art

The landing wheel assemblies of aircraft have changed little over the years relative to other aircraft components, in spite of the ever increasing speed and weight of conventional aircraft. During landing, the landing wheels on most conventional aircraft remain stationary while the aircraft is moving at a high rate of speed relative to the runway. At touchdown, when the wheels contact the runway, they are caused to spin instantaneously to match the speed of the aircraft, resulting in dramatic tire wear.

As a result of the tire wear and instantaneous acceleration, the tire can wear unevenly or even rupture, possibly causing loss of control and jeopardizing the safety of the aircraft, passengers, and crew. Inducing rotation in the landing wheels prior to landing greatly reduces tire wear and increases safety.

There are several patents which disclose apparatus and systems which induce pre-rotation of the landing wheel of an aircraft by affixing some type of air catching appendage to the wheel or modifying the wheel structure to act as an impeller.

Moore, U.S. Pat. No. 3,1768,135 discloses a rotator assembly for a toroidal aircraft wheel comprising an annular plate having inner and outer diameters substantially equal to the inner and outer diameters of the outer side of the tire and a concave inner side conforming to the curvature of the outer side of the tire. The plate has a plurality of integral concavoconvex air scoops which are rigid and fixed to the plate. The scoops have a concave side facing forward at the bottom half of the plate for receiving the airstream and a convex side facing forwardly at the upper half of the plate for deflecting the airstream. The scoops are also spirally curved, in both longitudinal and transverse planes perpendicular and parallel, respectively, of the axis of the plate.

Rubin, U.S. Pat. No. 3,233,849 discloses a rotator assembly having a plurality of scoops or vanes integral with the tire sidewall or a hubcap secured to the hub of the wheel. The scoops have an open end outstanding from the sidewall of the tire and a closed end substantially flush with the sidewall. The open ends of the scoops face in a wind catching direction below the axis of rotation and have a streamlined exterior contour extending from the open end to an apex at the closed end. The external contour of the scoops have a radius of curvature greater than that of the sidewall.

Hawkins, U.S. Pat. No. 4,061,294 discloses an aircraft wheel rotator comprising plow-like deflectors and fan-like spokes on the wheels. The plow-like deflectors cause air impinging thereon to be funneled downwardly and rearwardly with increased velocity, and thence backward to impinge on the fan-like spokes which are integral with the aircraft wheels.

McSweeney, U.S. Pat. No. 4,205,812 discloses a plurality of generally cross-shaped aircraft landing wheel-rotating devices, which are attached to the hub of the wheel in an eccentric pattern. Each generally cross-shaped device has a central cylindrical body portion which extends perpendicularly outwardly from the hub and four semi-cylindrical wind catching portions extending radially outwardly from the central body portion at right angles to one another and parallel to the hub. The concave surfaces of the semi-cylindrical portions catch the wind causing the wheel to rotate.

Maclean et al, U.S. Pat. No. 4,383,665 discloses an improved aircraft landing wheel which has a hub with spaced curved arms extending radially from the center of the hub and a plurality of normally flat flexible fins which are pivotally supported by pivot pins mounted on the radially extending curved arms. When the fins are below the horizontal axis of the hub, the wind causes the fins to assume an overlapped curved, wind-catching configuration extending radially from the center of the hub, and when the fins are above the horizontal axis, they pivot outwardly from the pivot pins in spaced apart relation to reduce wind resistance.

Soderberg, U.S. Pat. No. 4,385,739 discloses a system for rotating an aircraft wheel wherein the aircraft wheel is provided with a circular housing having a plurality of radially spaced surfaces and a nozzle having an outlet positioned adjacent the radial surfaces for directing a stream of air from the aircraft's engines or other source onto the radial surfaces to rotate the wheel.

Hartley, U.S. Pat. No. 5,104,063 discloses a system for rotating an aircraft wheel wherein the aircraft wheel is provided with a plurality of radially curved impellers and a system of air intake ducts with servo motor driven inlet vanes which gate incoming air to the impellers. A system of sensors, microcontroller, motors, and control linkages, continually measures ground speed during approach and translates the data into required RPM for each wheel and monitors the RPM of each wheel through non-contact photo-tachometers to provide precise control of the RPM of each wheel to bring them up to synchronous ground speed during approach to a landing. The design constraints of conventional aircraft landing wheels and the adjacent landing gear structures, such as the radius of the wheel and the wheel clearance between the retract bay surfaces limit the size of fixed scoop designs, and thus limit the amount of RPM's which can be induced by fixed scoop designs. For example, the width of the air catching surface of a fixed scoop is determined by the radius of the tire or tire rim and its height above the surface of the tire or rim is determined by the amount of space between the tire or rim and the adjacent structure, such as the surfaces of the retract bay. As a result, the cross sectional area available to catch the air and the energy transmitted to the wheel is limited. Another problem with fixed scoop designs is that as the wheel rotates, the front and rear of the scoops are reversed with respect to the airstream direction and the size of the air catching surfaces which impart rotation during the power cycle of rotation will also present a resistance to the airstream as the scoops move about the center of rotation which tends to reduce rotation during the return cycle.

Lamont, U.S. Pat. No. 4,732,350 discloses an aircraft wheel rotation assembly, which includes a plurality of vanes, equally spaced around the rim of the wheel. Each vane is provided with an integral segment gear, which is engaged with a ring gear carried by the assembly. The ring gear is rotated hydraulically to rotate the vanes in unison from a fully retracted position to a fully extended position or intermediate positions between the fully retracted and extended positions. With the Lamont apparatus all the vanes are extended and retracted in unison (at the same time) regardless of where they are above or below the center of rotation. Thus, the air catching surfaces, which impart rotation during the power cycle of rotation, will also present a resistance to the airstream as the scoops move about the center of rotation, which tends to reduce rotation during the return cycle.

The present invention is distinguished over the prior art in general, and these patents in particular by an aircraft landing wheel rotator assembly which has a circular plate mounted on the wheel and a plurality of independently movable scoops connected to the outer surface of the plate in circumferentially spaced relation. Each scoop has a leading edge facing generally in the direction in which the wheel is to be rotated, a convex curved trailing edge facing generally opposite the direction in which the wheel is to be rotated, and a central portion extending from the leading edge to the trailing edge. The leading edge is pivotally connected to the plate and the trailing edge is movable a distance outward relative to the plate outer surface. The airstream engages the convex trailing edge of the scoops which face generally toward the airstream to pivot them outward a distance from the plate to expose a surface area to the airstream which is greater than the surface area of the leading edge and central portion of the scoops which face generally away from the airstream such that the net torque force imparts rotation to the wheel. As the wheel rotates, the scoops, which were previously pivoted outward, become engaged by the airstream and are sequentially forced inward against the plate. An actuator may be connected with the scoops to selectively maintain all of the scoops inward against the plate to maintain the landing wheel in a substantially non-rotating condition or to allow each of the scoops to pivot independently.

### BRIEF DESCRIPTION OF THE DRAWINGS

FIGS. 1-6 illustrate apparatus according to a first aspect of the invention in combination with a wheel and pneumatic tire. The wheel consists essentially of a wheel hub and a wheel rim on which the pneumatic tire is mounted. The hub is mounted on an axle by means of bearings in the normal manner.

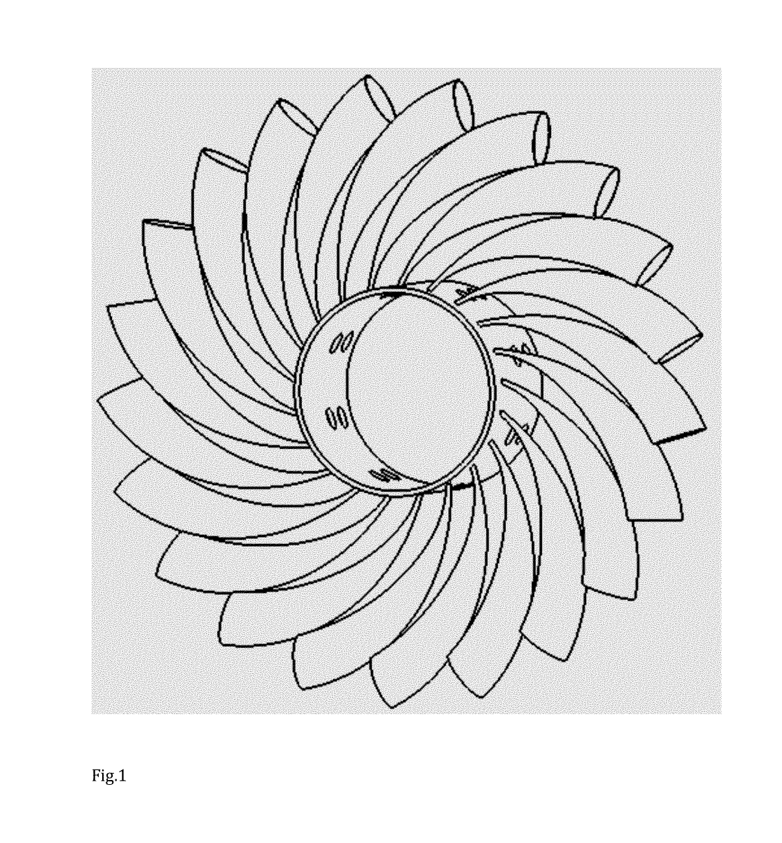

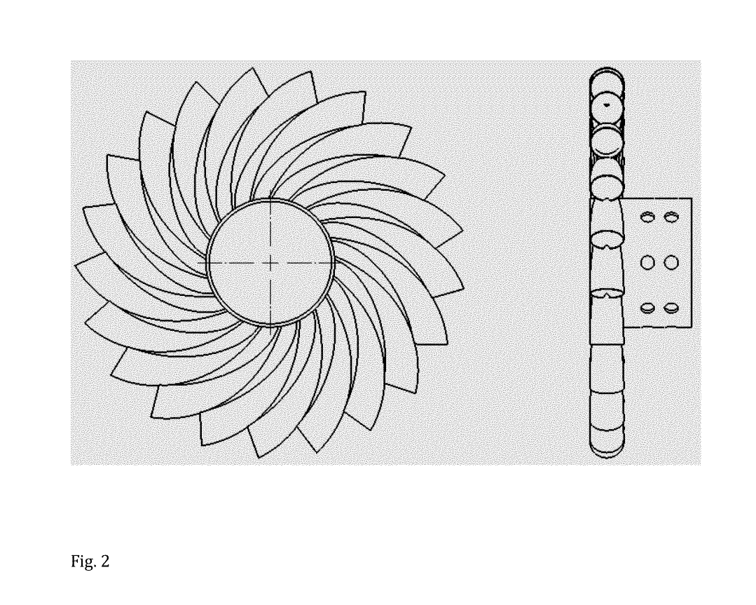

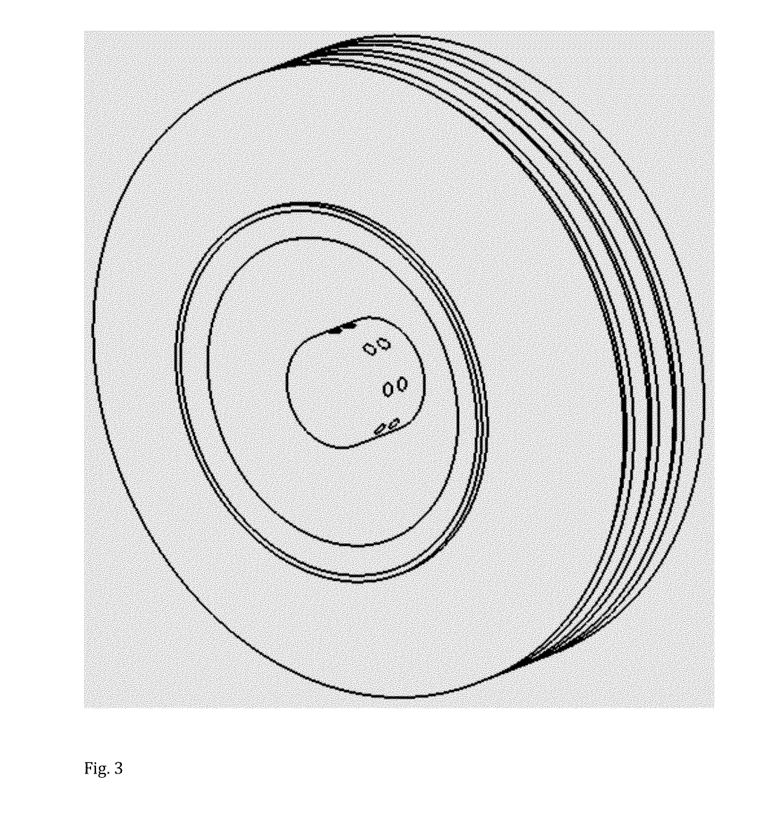

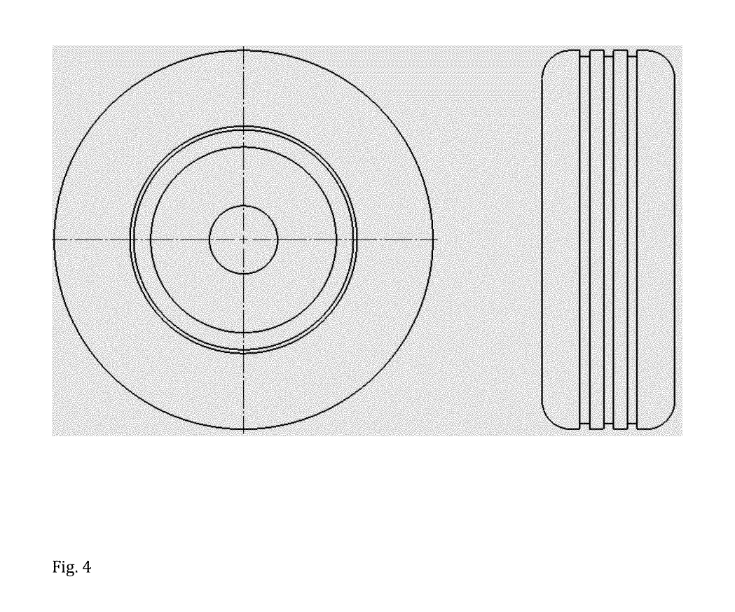

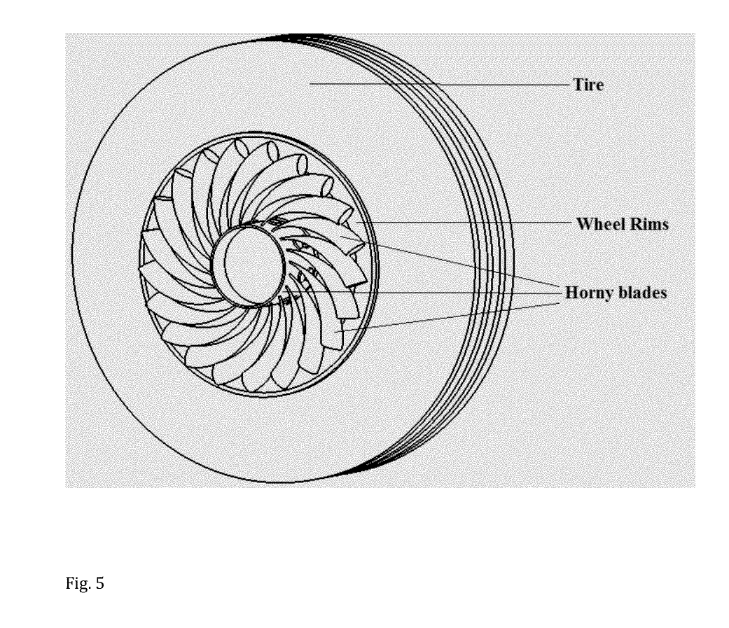

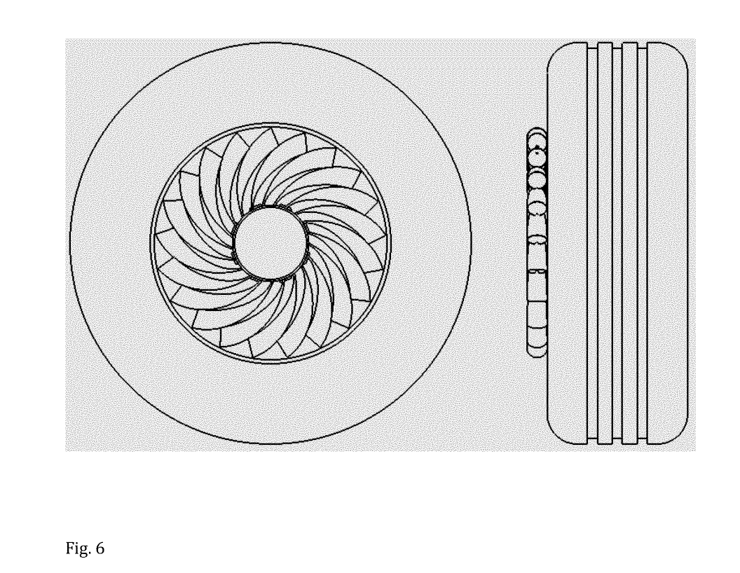

A flat circular plate or disc is removably mounted on the outer side of the end plate of the cylindrical drum by screws or other conventional fastening means. The disc covers the recessed portion 16 of the drum end plate and has an outer diameter approximately the same diameter as the peripheral flange.

A plurality of cone-shaped blades is hingedly connected to the outer surface of the disc in circumferentially spaced relation near the outer periphery of the disc by hinges. Arrows represent the direction of rotation of the wheel assembly and the airstream flowing by the wheel is represented by arrows. In the following description the term “circle leading edge” is defined as the edge facing in the direction of rotation of the wheel.

In a preferred embodiment, the cone-shaped blades are formed of resilient material, such as a flexible rubber or plastic material and may also contain reinforcing materials.

### SUMMARY OF THE INVENTION

It is therefore an object of the present invention to provide an aircraft landing wheel rotator having air cone shape member, which will catch the air and induce rotation of the wheel prior to landing.

It is another object of this invention to provide an aircraft landing wheel rotator having air scoops which will harness a maximum amount of air flow on the power cycle of rotation and offer very little resistance on the return cycle.

Another object of this invention is to provide an aircraft landing wheel rotator having movable scoops which will present a large surface area to engage the airstream on the power cycle of rotation and present a relatively small surface area on the return cycle.

Another object of this invention is to provide an aircraft landing wheel rotator having air scoops which present a large surface area to engage the airstream on the power cycle of rotation and present a relatively small surface area on the return cycle and will not interfere with the adjacent surfaces of the retract bay or landing gear structure.

A further object of this invention is to provide an aircraft landing wheel rotator system, which can be selectively controlled by the pilot to be operative or inoperative.

A still further object of this invention is to provide an aircraft landing wheel rotator which is simple in design, economical to manufacture, and rugged and reliable in use.

Other objects of the invention will become apparent from time to time throughout the specification and claims as hereinafter related. The above noted objects and other objects of the invention are accomplished by an aircraft landing wheel rotator assembly which has a circular plate mounted on the wheel and a plurality of independently movable cone shaped members connected to the outer surface of the plate in circumferentially spaced relation. Each member has a circle leading edge facing generally in the direction in which the wheel is to be rotated. The cone shape members are connected to the plate and the trailing edge is movable a distance outward relative to the plate outer surface. The airstream engages the circle leading edge of the member which face generally toward the airstream to pivot them outward a distance from the plate to expose a surface area to the airstream which is greater than the surface area of the leading edge and central portion of the scoops which face generally away from the airstream such that the net torque force imparts rotation to the wheel. As the wheel rotates, the members, which were previously pivoted outward, become engaged by the airstream and are sequentially forced inward against the plate. An actuator may be connected with the members to selectively maintain all of the scoops inward against the plate to maintain the landing wheel in a substantially non-rotating condition or to allow each of the members to pivot independently.

We claim:

1. A rotator assembly for rotating an aircraft-landing wheel by the action of the airstream flowing thereby comprising:
a circular plate adapted to be mounted on an aircraft-landing wheel;
a plurality of independently movable cone shape members connected to an outer surface of said plate in circumferentially spaced relation about the axis of rotation of the wheel and each having an opening facing generally in the direction in which the wheel is to be rotated,
wherein all of said cone shaped members are maintained inward against said plate outer surface and a pivoting condition allowing each one of said cone shaped members to pivot independently relative to said plate outer surface; and
the airstream engaging said cone shaped members which face generally toward the airstream; and wherein
as the wheel rotates, said cone shaped members are sequentially forced inward against said plate outer surface.
